(19) United States
(12) Patent Application Publication
(10) Pub. No.: US 2025/0147526 A1
(43) Pub. Date: May 8, 2025

(54) CONTROL PARAMETER CALCULATION APPARATUS, CONTROL PARAMETER CALCULATION METHOD, AND CONTROL PARAMETER CALCULATION PROGRAM

(71) Applicant: HORIBA STEC, Co., Ltd., Kyoto (JP)

(72) Inventors: Seiji HIGUCHI, Kyoto-shi (JP); Kotaro TAKIJIRI, Kyoto-shi (JP)

(21) Appl. No.: 18/938,474

(22) Filed: Nov. 6, 2024

(30) Foreign Application Priority Data
Nov. 7, 2023 (JP) 2023-189823

(51) Int. Cl. G05D 7/06

(52) U.S. Cl. CPC G05D 7/0623

(57) ABSTRACT

A control parameter calculation apparatus calculates a control parameter of a fluid control apparatus that controls a fluid. The control parameter calculation apparatus stores correlation data indicating a correlation of a reference control parameter of the fluid control apparatus and a reference response signal output by using the reference control parameter, acquires a target response signal output by using a target control parameter of the fluid control apparatus different from the fluid control apparatus serving as a reference, acquires the correlation data and the target response signal and calculates a correlation control parameter corresponding to the target response signal in the fluid control apparatus serving as a reference by using the correlation data, and calculates an adjustment amount of the target control parameter based on the correlation control parameter and the reference control parameter.

### CROSS-REFERENCE TO RELATED APPLICATION(S)

The present application claims priority to Japanese Patent Application No. 2023-189823 filed Nov. 7, 2023, entitled CONTROL PARAMETER CALCULATION APPARATUS, CONTROL PARAMETER CALCULATION METHOD, AND CONTROL PARAMETER CALCULATION PROGRAM which is incorporated herein by reference in its entirety.

### BACKGROUND OF THE INVENTION

### Technical Field

The present invention relates to a control parameter calculation apparatus, a control parameter calculation method, and a control parameter calculation program.

### Description of the Related Art

A fluid control apparatus that controls a fluid flowing through a flow path has conventionally been proposed. This type of fluid control apparatus includes a control valve provided in a flow path, a flow rate sensor that measures a flow rate of a fluid flowing through the flow path, and a valve controller that controls the valve based on a flow rate that has been measured by the flow rate sensor, as described in JP 2022-84110 A, for example.

In the fluid control apparatus described above, a set flow rate of the fluid flowing through the flow path is input to the valve controller, and the valve controller compares the measured flow rate with the set flow rate to perform PID control on the opening degree of the control valve. Here, in general, control parameters such as a proportional gain, an integral gain, and a differential gain are used in PID control, and the valve controller performs PID control on the opening degree of the control valve based on the control parameters.

### PRIOR ART DOCUMENT

### Patent Document

JP 2022-84110 A

### SUMMARY OF THE INVENTION

Here, it is necessary to set appropriate control parameters for the fluid control apparatus to exhibit a favorable response. However, since the fluid control apparatus has a device difference, even though a certain fluid control apparatus has a control parameter indicating a good response, there is a possibility that another fluid control apparatus does not exhibit a good response when the same control parameters are used. For example, an overshoot occurs or rising is delayed in another fluid control apparatus. As a result, there is a need to adjust the control parameters for the fluid control apparatus to exhibit a good response, and the adjustment of the control parameters has conventionally performed based on the experience of the user.

However, when the control parameters are adjusted based on the experience of the user, the user may adjust the control parameters many times depending on the ability of the user, and it takes time to set the control parameters.

The present invention has been made in view of the above-described problems, and a main object of the present invention is to adjust a control parameter of a fluid control apparatus in a short time without depending on the experience of a user in a control parameter calculation apparatus that calculates the control parameter.

That is, a control parameter calculation apparatus according to the present invention is a control parameter calculation apparatus that calculates a control parameter of a fluid control apparatus that controls a fluid, including a correlation data storage unit that stores correlation data indicating a correlation of a reference control parameter of a reference device that is a fluid control apparatus serving as a reference and a reference response signal output by using the reference control parameter, a target response signal acquisition unit that acquires a target response signal output by using a target control parameter of a target device that is a fluid control apparatus different from the reference device, a correlation control parameter calculation unit that acquires the correlation data and the target response signal and calculates a correlation control parameter corresponding to the target response signal in the reference device by using the correlation data, and a target control parameter adjustment amount calculation unit that calculates an adjustment amount of the target control parameter based on the correlation control parameter and the reference control parameter.

Such a control parameter calculation apparatus calculates the correlation control parameter by using the correlation data and calculates the adjustment amount of the target control parameter based on the correlation control parameter and the reference control parameter. Thus, the target control parameter can be adjusted without depending on the experience of the user. Adjusting the target control parameter based on the calculated adjustment amount of the target control parameter in the target fluid control apparatus eliminates the need of adjusting the target control parameter many times, and the target control parameter can be adjusted more efficiently.

In addition, since the adjustment amount of the target control parameter is calculated based on the correlation control parameter and the reference control parameter, it is less likely to be affected by the device difference between the reference fluid control apparatus and the target fluid control apparatus as compared with the configuration in which the control parameter itself of the target fluid control apparatus is calculated.

Further, since the target control parameter is calculated by using the correlation data of the fluid control apparatus serving as the reference, the correlation data of the target fluid control apparatus is not needed when the target control parameter is calculated.

It is preferable that the target response signal acquisition unit acquires a plurality of the target response signals, and the correlation control parameter calculation unit calculates one or one set of the correlation control parameters from the plurality of target response signals.

With such a configuration, the correlation control parameter calculation unit calculates one or a set of correlation control parameters from the plurality of target response signals. Thus, it is possible to improve the accuracy of calculating the correlation control parameters as compared with the case of calculating one set of correlation control parameters based on one target response signal.

It is desirable the target control parameter adjustment amount calculation unit obtains a difference between the correlation control parameter and the reference control parameter and sets the difference as the adjustment amount of the target control parameter.

With such a configuration, the difference between the correlation control parameter and the reference control parameter becomes the adjustment amount of the target control parameter. Thus, the target control parameter can be adjusted only by changing the target control parameter based on the difference, and the target control parameter can be easily adjusted.

As a specific aspect of calculating the correlation control parameter, one in which the correlation control parameter calculation unit calculates the correlation control parameter from the target response signal using a Gaussian mixture regression model can exemplified.

With such a configuration, the correlation control parameters can be accurately calculated by using the Gaussian mixture regression model particularly when one or a set of correlation control parameters is calculated from a plurality of target response signals.

Here, since deterioration does not occur in the target device at the time of initial setting in which the target control parameter is set for the first time, it is considered that the fluctuation of the control parameter due to the deterioration is small. Thus, it is considered that in the target device at the time of initial setting, the difference in the control parameter between the target device and the reference device is mainly because of the device difference between the target device and the reference device.

Thus, the target response signal acquisition unit preferably acquires the target response signal output by using the target control parameter of the target device at the time of initial setting, and the correlation control parameter calculation unit preferably calculates the correlation control parameter from the target response signal of the target device at the time of initial setting.

With such a configuration, it is considered that the difference between the correlation control parameter and the reference control parameter is because of the device difference between the reference device and the target device, and thus, it is possible to accurately calculate the adjustment amount of the target control parameter.

As the correlation data storage unit, a correlation data storage unit that stores the correlation data created by using machine learning can be exemplified.

With such a configuration, the correlation data created by using machine learning is stored, which can improve the accuracy of the correlation data.

A control parameter calculation method is a control parameter calculation method for calculating a control parameter of a fluid control apparatus that controls a fluid, the control parameter calculation method including storing correlation data indicating a correlation of a reference control parameter of a reference device that is a fluid control apparatus serving as a reference and a reference response signal output by using the reference control parameter, acquiring a target response signal output by using a target control parameter of a target device that is a fluid control apparatus different from the reference device, acquiring the correlation data and the target response signal and calculating a correlation control parameter corresponding to the target response signal in the reference device by using the correlation data, and calculating an adjustment amount of the target control parameter based on the correlation control parameter and the reference control parameter.

Such a configuration can obtain the same operation and effect as those of the control parameter calculation apparatus described above.

Further, a control parameter calculation program that is used for a fluid control apparatus that controls a fluid, the control parameter calculation program calculating a control parameter of the fluid control apparatus, causes a computer to exert a function as a correlation data storage unit that stores correlation data indicating a correlation of a reference control parameter of a reference device that is a fluid control apparatus serving as a reference and a reference response signal output by using the reference control parameter, a function as a target response signal acquisition unit that acquires a target response signal output by using a target control parameter of a target device that is a fluid control apparatus different from the reference device, a function as a correlation control parameter calculation unit that acquires the correlation data and the target response signal and calculates a correlation control parameter corresponding to the target response signal in the reference device by using the correlation data, and a function as a target control parameter adjustment amount calculation unit that calculates an adjustment amount of the target control parameter based on the correlation control parameter and the reference control parameter.

Such a configuration can obtain the same operation and effect as those of the control parameter calculation apparatus described above.

The present invention with such configurations can adjust a control parameter of a fluid control apparatus in a short time without depending on the experience of a user in a control parameter calculation apparatus that calculates the control parameter.

### BRIEF DESCRIPTION OF THE DRAWINGS

FIG. 1 is a schematic diagram illustrating a control parameter calculation apparatus and a fluid control apparatus according to an embodiment of the present invention;

FIG. 2 is a functional block diagram of the control parameter calculation apparatus according to the embodiment; and

FIG. 3A is a graph showing a correlation between a control parameter and a response signal in a reference device, and FIG. 3B is a graph showing a correlation between a control parameter and a response signal in a target device according to the embodiment.

### DETAILED DESCRIPTION

Hereinafter, an embodiment of a control parameter calculation apparatus that calculates a control parameter of a fluid control apparatus according to the present invention will be described with reference to the drawings. The following drawings may be schematically illustrated with omission or exaggeration as appropriate for easy understanding. The same components are denoted by the same reference numerals, and the description thereof will be omitted as appropriate.

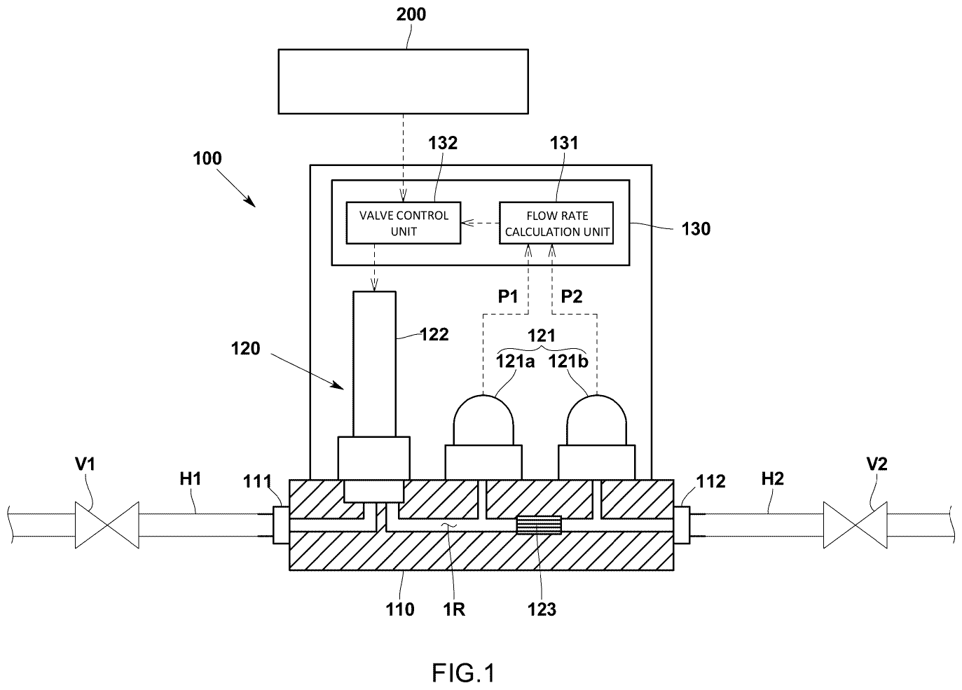

As illustrated in FIG. 1, a control parameter calculation apparatus 200 according to the present embodiment calculates a control parameter of a fluid control apparatus 100 that controls a fluid flowing through a flow path.

Here, the fluid control apparatus 100 targeted by the control parameter calculation apparatus 200 is a so-called differential pressure type mass flow controller (differential pressure type MFC), and it includes, as illustrated in FIG. 1, a flow path block 110 in which a plurality of internal flow paths 1R are formed, a fluid control device 120 provided in the flow path block 110, and a control unit 130 that controls the fluid control device 120. Hereinafter, each unit of the fluid control apparatus 100 targeted by the control parameter calculation apparatus 200 will be described.

The flow path block 110 is provided with an inlet port 111 that introduces a fluid into the internal flow path 1R and an outlet port 112 that leads out the fluid from the internal flow path 1R. The inlet port 111 is connected with an upstream pipe H1, and the upstream pipe H1 is provided with an upstream pneumatic valve V1. The outlet port 112 is connected with a downstream pipe H2, and the downstream pipe H2 is provided with a downstream pneumatic valve V2.

The fluid control device 120 controls the fluid in the internal flow path 1R, including a flow rate sensor 121 that measures the flow rate of the fluid flowing through the internal flow path 1R, and a fluid control valve 122 provided on the upstream side of the flow rate sensor 121. The fluid control valve 122 performs PID control of the flow rate of the fluid flowing through the internal flow path 1R with the control unit 130 described later.

The flow rate sensor 121 is a differential pressure type flow rate sensor, including an upstream pressure sensor 121a provided on the upstream side of a fluid resistance element 123 such as a restrictor or an orifice provided in the internal flow path 1R, and a downstream pressure sensor 121b provided on the downstream side of the fluid resistance element 123. The flow rate calculation unit 131 of the control unit 130 described later calculates the flow rate flowing through the internal flow path 1R using an upstream side pressure P1 of the fluid resistance element 123 detected by the upstream pressure sensor 121a and a downstream side pressure P2 of the fluid resistance element 123 detected by the downstream pressure sensor 121b.

The fluid control valve 122 is provided on the upstream side of the flow rate sensor 121. Specifically, the fluid control valve 122 controls the flow rate by moving the valve body forward and backward with respect to the valve seat with a piezo actuator. The fluid control valve 122 is controlled by a valve control unit 132 of the control unit 130.

The control unit 130 includes a flow rate calculation unit 131 that calculates the flow rate flowing through the internal flow path 1R based on the upstream side pressure P1 and the downstream side pressure P2, and a valve control unit 132 that controls the fluid control valve 122 based on the flow rate calculated by the flow rate calculation unit 131. The control unit 130 is, for example, a so-called computer including a CPU, a memory, an A/D-D/A converter, and an input/output unit, and it exhibits the functions as the flow rate calculation unit 131, the valve control unit 132, and the like by executing a flow rate control program stored in the memory and cooperating with various devices.

The flow rate calculation unit 131 calculates the flow rate flowing through the internal flow path 1R using an existing flow rate calculation formula. Examples of the existing flow rate calculation formula include a formula in which the flow rate is calculated by multiplying a difference between the square of the upstream side pressure P1 and the square of the downstream side pressure P2 by a predetermined coefficient, but other flow rate calculation formulas may be used.

The valve control unit 132 acquires a set flow rate and performs PID control based on the calculated flow rate and the deviation of the set flow rate to control the flow rate flowing through the internal flow path 1R. The valve control unit 132 stores a control parameter such as a proportional gain, an integral gain, or a differential gain, and the valve control unit 132 performs PID control using the control parameter.

Next, a configuration of the control parameter calculation apparatus 200 will be described.

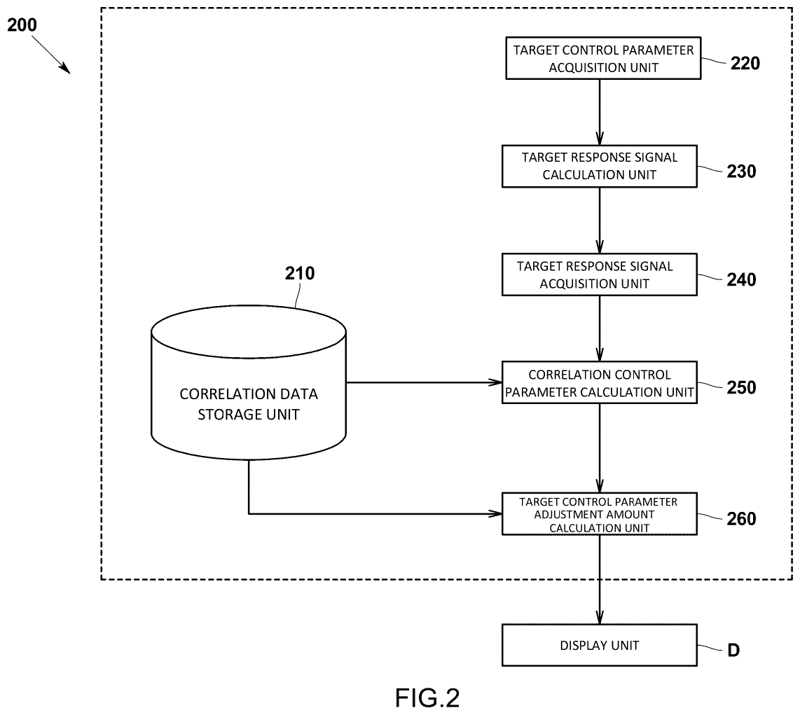

The control parameter calculation apparatus 200 calculates the control parameter used by the valve control unit 132. The control parameter calculation apparatus 200 is a so-called computer including, for example, a CPU, a memory, an A/D-D/A converter, and an input/output unit. The control parameter calculation apparatus 200 exhibits at least the functions as a correlation data storage unit 210, a target response signal acquisition unit 240, a correlation control parameter calculation unit 250, and a target control parameter adjustment amount calculation unit 260 as illustrated in FIG. 2 by executing the flow rate control program stored in the memory and cooperating with various devices.

The correlation data storage unit 210 stores correlation data indicating a correlation between a reference control parameter of a fluid control apparatus serving as a reference (hereinafter, referred to as a reference device) and a reference response signal output by using the reference control parameter. In the present embodiment, the reference device refers to a fluid control apparatus in which the control parameter has not changed or the change in the control parameter is within an allowable range as compared with the control parameter set for the first time. Here, the reference control parameter is a control parameter for the valve control unit 132 of the reference device to perform PID control. The reference response signal corresponds to the reference control parameter with the correlation data, and is specifically, for example, a response signal such as a response time until the flow rate measured by the flow rate sensor 121 reaches a predetermined flow rate, an overshoot amount in which the flow rate measured by the flow rate sensor 121 exceeds a set flow rate, or a hunting amount which is a time required until the flow rate measured by the flow rate sensor 121 is stabilized when the valve control unit 132 of the reference device performs PID control using the reference control parameter. In addition, in the present embodiment, the correlation data causes the reference control parameter and the reference response signal to correspond to each other on a one-to-one basis, in other words, when the reference control parameter is determined, the reference response signal is determined based on the correlation data.

Here, the correlation data is created by the valve control unit 132 of the reference device performing PID control on the flow rate of the fluid flowing through the internal flow path 1R using the reference control parameter and correlating the reference control parameter and the reference response signal at that time. Specifically, the valve control unit 132 of the reference device performs PID control using the reference control parameter. Then, the control parameter calculation apparatus 200 acquires a response waveform from the flow rate measured by the flow rate sensor 121, acquires a reference response signal from the response waveform, and correlates the reference control parameter and the reference response signal at that time. The above operation is performed on all the reference control parameters in the predetermined range, and all the control parameters and the reference response signals in the predetermined range are correlated with each other, whereby correlation data is created. The created correlation data is stored in the correlation data storage unit 210.

The target response signal acquisition unit 240 acquires a target response signal output by using a target control parameter of a fluid control apparatus (hereinafter, referred to as a target device) different from the reference device. Here, the reference control parameter is a control parameter for the valve control unit 132 of the target device to perform PID control. The target response signal is, for example, a response signal such as a response time, an overshoot amount, or a hunting amount when the valve control unit 132 of the target device performs PID control using the target control parameter.

In the present embodiment, for the target response signal acquisition unit 240 to acquire the target response signal, the target control parameter acquisition unit 220 acquires the target control parameter, and the target response signal calculation unit 230 acquires the response waveform from the flow rate measured by the flow rate sensor 121 at that time when the valve control unit 132 of the target device performs PID control based on the target control parameter, and calculates the target response signal in the response waveform. Then, the target response signal acquisition unit 240 acquires the target response signal calculated by the target response signal calculation unit 230.

The correlation control parameter calculation unit 250 calculates a correlation control parameter that is a control parameter of the reference device corresponding to the target response signal by using the correlation data. Specifically, the correlation control parameter is a reference control parameter in the case where it is assumed that the reference device has output the target response signal, and the correlation control parameter calculation unit 250 calculates the correlation control parameter from the target response signal by using the correlation data. In the present embodiment, the correlation data used by the correlation control parameter calculation unit 250 is, for example, a Gaussian mixture regression model, but the data is not limited to this model.

In the present embodiment, the correlation control parameter calculation unit 250 calculates a set of correlation control parameters from a plurality of target response signals. Specifically, the target response signal acquisition unit 240 acquires a plurality of target response signals. Here, the plurality of target response signals are, for example, at least two or more of a response time, an overshoot amount, and a hunting amount. Then, the correlation control parameter calculation unit 250 acquires the plurality of target response signals and calculates one set of correlation control parameters including a proportional gain P and an integral gain I using the correlation data.

In the present embodiment, the correlation control parameter calculated by the correlation control parameter calculation unit 250 is calculated based on the target response signal of the target device at the time of initial setting in which the target control parameter is set for the first time. In the present embodiment, the initial setting means that the target control parameter is set until the target device is installed in a flow path for the first time after production of the target device. Specifically, the target response signal acquisition unit 240 acquires the target response signals of the target device at the time of initial setting. Then, the correlation control parameter calculation unit 250 acquires the target response signals of the target device at the time of initial setting and calculates the correlation control parameters using the correlation data.

The target control parameter adjustment amount calculation unit 260 calculates the adjustment amount of the target control parameter based on the correlation control parameter and the reference control parameter. Specifically, the target control parameter adjustment amount calculation unit 260 obtains a difference between the correlation control parameter and the reference control parameter and sets the difference as the adjustment amount of the target control parameter.

### <Method for Calculating Control Parameter>

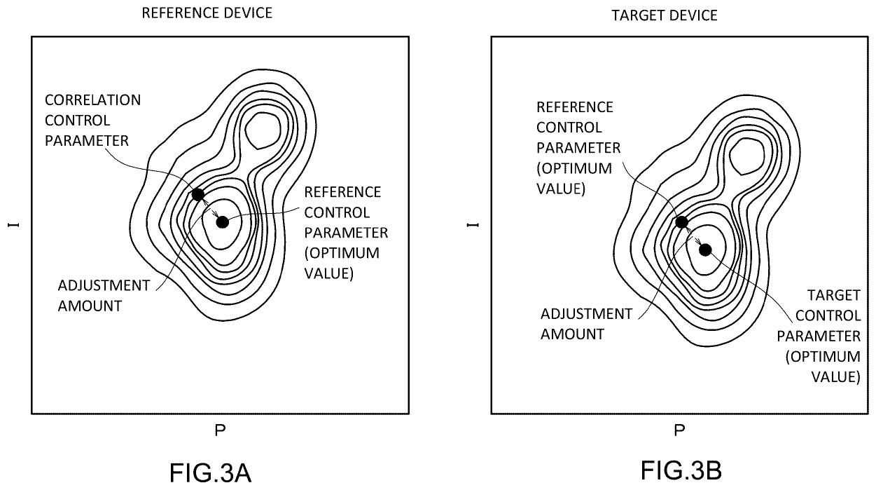

Next, a control parameter calculation method for calculating a control parameter using the control parameter calculation apparatus 200 according to the present embodiment will be described with reference to FIGS. 3A and 3B.

FIG. 3A is a graph showing a correlation between the reference control parameter and the reference response signal in the reference device. FIG. 3A is a graph of control parameters with a proportional gain P on the horizontal axis and an integral gain I on the vertical axis. In FIG. 3A, an index of the reference response signal is indicated by contour lines in which a region of the reference control parameter where the equivalent reference response signal is output is indicated by the same line.

Here, the index of the reference response signal is, for example, a value evaluated by giving a score to a combination of the overshoot amount and the response time, and the index of a more ideal reference response signal has a higher value to be evaluated. In FIG. 3A, a region surrounded by more contour lines indicates a more ideal reference response signal, and the reference control parameter corresponding to the most ideal reference response signal is an optimum value of the reference control parameter. The optimum value of the reference control parameter here is, for example, a reference control parameter in a case where a physical quantity indicating a reference response signal such as a response time, an overshoot amount, or a hunting amount has, for example, a minimum value.

FIG. 3B is a graph showing an example of the correlation between the target control parameter and the target response signal in the target device. FIG. 3B is a graph of control parameters with the proportional gain P on the horizontal axis and the integral gain I on the vertical axis as in FIG. 3A. In FIG. 3B, as in FIG. 3A, an index of the target response signal is indicated by contour lines in which a region of the target control parameter where the equivalent target response signal is output is indicated by the same line.

In FIG. 3B, the distribution shape of the graph of the target device indicating the region of the target control parameter and the index of the target response signal largely depends on the deterioration of the target device. In particular, with the target device at the time of initial setting, the distribution shape of the graph of the target device is considered to be substantially equal between the devices. That is, with the target device at the time of initial setting, as illustrated in FIG. 3B, the distribution shape of the graph of the target device is substantially the same as the distribution shape of the graph of the reference device illustrated in FIG. 3A, but the proportional gain P and the integral gain I of the target device are shifted from the proportional gain P and the integral gain I of the reference device because of the device difference between the target device and the reference device.

The control parameter calculation apparatus 200 of the present embodiment calculates, particularly in the target device at the time of initial setting, the adjustment amount of the target control parameter by using only the correlation data in the reference device without creating the correlation data of the target device, using the difference between the graph of the target device and the graph of the reference device, the difference being made only because of the device difference. A specific calculation of the adjustment amount of the target control parameter will be described below.

The target control parameter acquisition unit 220 acquires a target control parameter of the target device. Here, the target device from which the target control parameter is acquired is the target device at the time of initial setting. The target control parameter acquired by the target control parameter acquisition unit 220 is an optimum value of the reference control parameter. The target control parameter acquired by the target control parameter acquisition unit 220 is not limited to an optimum value of the reference control parameter, but it may be another value.

The target response signal calculation unit 230 calculates a target response signal by acquiring a response waveform from the flow rate measured by the flow rate sensor 121 at the time when the valve control unit 132 of the target device performs PID control based on the target control parameter. In the present embodiment, as illustrated in FIG. 3B, the target response signal is a response signal of the target device when the valve control unit 132 of the target device performs PID control based on the optimum value of the reference control parameter. Then, the target response signal acquisition unit 240 acquires the target response signal calculated by the target response signal calculation unit 230. Here, the target response signal acquisition unit 240 acquires a plurality of target response signals such as a response time and an overshoot amount.

The correlation control parameter calculation unit 250 calculates a correlation control parameter from the target response signal acquired by the target response signal acquisition unit 240 using the correlation data stored in the correlation data storage unit 210. In the present embodiment, the correlation control parameter calculation unit 250 acquires the plurality of target response signals and calculates one set of correlation control parameters including the proportional gain P and the integral gain I using a Gaussian mixture regression model, as illustrated in FIG. 3A.

The target control parameter adjustment amount calculation unit 260 acquires the correlation data from the correlation data storage unit 210, acquires the optimum value of the reference control parameter, and acquires the correlation control parameter from the correlation control parameter calculation unit 250. Then, the target control parameter adjustment amount calculation unit 260 obtains a difference between the correlation control parameter and the optimum value of the reference control parameter and sets the difference as the adjustment amount of the target control parameter, as illustrated in FIG. 3A.

When the adjustment amount of the target control parameter is calculated, the control parameter calculation apparatus 200 calculates the optimum value of the target control parameter based on the calculated adjustment amount of the target control parameter as illustrated in FIG. 3B. Specifically, the control parameter calculation apparatus 200 sets a value obtained by adding the adjustment amount of the target control parameter to the optimum value of the reference control parameter as the optimum value of the target control parameter. That is, the difference between the correlation control parameter and the optimum value of the reference control parameter in FIG. 3A corresponds to the difference between the optimum value of the reference control parameter and the optimum value of the target control parameter in FIG. 3B. In the present embodiment, the control parameter calculation apparatus 200 calculates the optimum value of the target control parameter, but the user may calculate the optimum value of the target control parameter.

Then, the optimum value of the target control parameter can be output to a display unit D such as a display, for example. Then, when the valve control unit 132 performs PID control based on the optimum value of the target control parameter, an ideal response in which the response time, the overshoot amount, or the hunting amount becomes, for example, the minimum value, is shown. In addition to the optimum value of the target control parameter, the adjustment amount of the target control parameter and other parameters may be displayed on the display unit D.

### Effects of Present Embodiment

The control parameter calculation apparatus 200 of the present embodiment, in which the correlation control parameter calculation unit 250 calculates the correlation control parameter using the correlation data, and the target control parameter adjustment amount calculation unit 260 calculates the adjustment amount of the target control parameter based on the correlation control parameter and the reference control parameter, can adjust the target control parameter without depending on the experience of the user. Adjusting the target control parameter based on the calculated adjustment amount of the target control parameter in the target device eliminates the need of adjusting the target control parameter many times, and the target control parameter can be adjusted more efficiently.

In addition, since the adjustment amount of the target control parameter is calculated based on the correlation control parameter and the reference control parameter, it is less likely to be affected by the device difference between the reference device and the target device as compared with the configuration in which the control parameter itself of the target device is calculated.

Further, since the target control parameter is calculated by using the correlation data of the reference device, the correlation data of the target device is not needed when the target control parameter is calculated.

In addition, the target control parameter adjustment amount calculation unit 260 obtains the difference between the correlation control parameter and the reference control parameter and sets the difference as the adjustment amount of the target control parameter. Thus, the target control parameter can be adjusted only by changing the target control parameter based on the difference, and the target control parameter can be easily adjusted.

The correlation control parameter calculation unit 250 in the present embodiment calculates one set of correlation control parameters from a plurality of target response signals. Thus, it is possible to improve the accuracy of calculating the correlation control parameters as compared with the case of calculating one set of correlation control parameters based on one target response signal. In particular, the correlation control parameter calculation unit 250, which uses a Gaussian mixture regression model, can accurately calculate target correlation control parameters when one set of correlation control parameters is calculated from a plurality of target response signals.

Further, since the target response signal acquisition unit 240 and the correlation control parameter calculation unit 250 use the target response signal of the target device at the time of initial setting, it is considered that the difference between the correlation control parameter and the reference control parameter is because of the device difference between the reference device and the target device, and it is possible to accurately calculate the adjustment amount of the target control parameter.

### Other Embodiments

The present invention is not limited to the above embodiment.

The fluid control apparatus 100 targeted by the control parameter calculation apparatus 200 in the present embodiment is a differential pressure type MFC. The fluid control apparatus is not limited to this configuration, and it may be a so-called thermal mass flow controller, a pressure control device, or another fluid control apparatus.

The correlation data storage unit 210 may store correlation data created through machine learning. Specifically, the control parameter calculation apparatus 200 or a calculation apparatus different from the control parameter calculation apparatus 200 calculates the reference response signal using the reference control parameter in the predetermined range, and calculates the correlation data through machine learning. The correlation data storage unit 210 then stores correlation data created through machine learning. This configuration can improve the accuracy of the correlation data.

In the present embodiment, the target response signal acquisition unit 240 and the correlation control parameter calculation unit 250 use a plurality of target response signals, but one target response signal may be used. In addition, the correlation control parameter calculation unit 250 calculates one set of correlation control parameters including the proportional gain P and the integral gain I. However, it is sufficient that the correlation control parameter calculation unit calculates at least one of the proportional gain P, the integral gain I, or the differential gain D, and the unit may calculate other control parameters.

In the present embodiment, the target control parameter adjustment amount calculation unit 260 adjusts the control parameter of the target device at the time of initial setting, but the unit is not limited to this configuration. For example, the target control parameter adjustment amount calculation unit 260 may adjust the control parameter of the target device set in a flow path and used for a certain period of time based on the reference control parameter and the correlation control parameter. This configuration allows the target control parameter adjustment amount calculation unit 260 to adjust the control parameter that has deteriorated and changed because of use of the target device.

In the present embodiment, the target control parameter adjustment amount calculation unit 260 obtains a difference between the correlation control parameter and the optimum value of the reference control parameter and sets the difference as the adjustment amount of the target control parameter. However, the unit is not limited to this configuration. For example, the target control parameter adjustment amount calculation unit 260 may acquire a reference control parameter other than the optimum value of the reference control parameter, obtain a difference between the correlation control parameter and the reference control parameter, and sets the difference as the adjustment amount of the target control parameter.

Other various modifications and combinations of the embodiments may be made without departing from the spirit of the present invention.

### REFERENCE CHARACTERS LIST

100 fluid control apparatus
121 flow rate sensor
122 flow rate control valve
132 valve control unit
200 control parameter calculation apparatus
210 correlation data storage unit
220 target control parameter acquisition unit
230 target response signal calculation unit
240 target response signal acquisition unit
250 correlation control parameter calculation unit
260 target control parameter adjustment amount calculation unit

What is claimed is:

1. A control parameter calculation apparatus that calculates a control parameter of a fluid control apparatus that controls a fluid, the control parameter calculation apparatus comprising:
a correlation data storage unit that stores correlation data indicating a correlation of a reference control parameter of a reference device that is a fluid control apparatus serving as a reference and a reference response signal output by using the reference control parameter;
a target response signal acquisition unit that acquires a target response signal output by using a target control parameter of a target device that is a fluid control apparatus different from the reference device;
a correlation control parameter calculation unit that acquires the correlation data and the target response signal and calculates a correlation control parameter corresponding to the target response signal in the reference device by using the correlation data; and
a target control parameter adjustment amount calculation unit that calculates an adjustment amount of the target control parameter based on the correlation control parameter and the reference control parameter.

2. The control parameter calculation apparatus according to claim 1, wherein
the target response signal acquisition unit acquires a plurality of the target response signals, and
the correlation control parameter calculation unit calculates one or one set of the correlation control parameters from the plurality of target response signals.

3. The control parameter calculation apparatus according to claim 1, wherein the target control parameter adjustment amount calculation unit obtains a difference between the correlation control parameter and the reference control parameter and sets the difference as the adjustment amount of the target control parameter.

4. The control parameter calculation apparatus according to claim 1, wherein the correlation control parameter calculation unit calculates the correlation control parameter from the target response signal using a Gaussian mixture regression model.

5. The control parameter calculation apparatus according to claim 1, wherein
the target response signal acquisition unit acquires the target response signal output by using the target control parameter of the target device at a time of initial setting when the target control parameter is set for a first time, and
the correlation control parameter calculation unit calculates the correlation control parameter from the target response signal of the target device at the time of initial setting.

6. The control parameter calculation apparatus according to claim 1, wherein the correlation data storage unit stores the correlation data created by using machine learning.

7. A control parameter calculation method for calculating a control parameter of a fluid control apparatus that controls a fluid, the control parameter calculation method comprising:
storing correlation data indicating a correlation of a reference control parameter of a reference device that is a fluid control apparatus serving as a reference and a reference response signal output by using the reference control parameter;
acquiring a target response signal output by using a target control parameter of a target device that is a fluid control apparatus different from the reference device;
acquiring the correlation data and the target response signal and calculating a correlation control parameter corresponding to the target response signal in the reference device by using the correlation data; and
calculating an adjustment amount of the target control parameter based on the correlation control parameter and the reference control parameter.

8. A non-transitory storage medium storing a control parameter calculation program that is used for a fluid control apparatus that controls a fluid, the control parameter calculation program calculating a control parameter of the fluid control apparatus, the control parameter calculation program being executable by a computer to:
store correlation data indicating a correlation of a reference control parameter of a reference device that is a fluid control apparatus serving as a reference and a reference response signal output by using the reference control parameter;
acquire a target response signal output by using a target control parameter of a target device that is a fluid control apparatus different from the reference device;
acquire the correlation data and the target response signal and calculates a correlation control parameter corresponding to the target response signal in the reference device by using the correlation data; and
calculate an adjustment amount of the target control parameter based on the correlation control parameter and the reference control parameter.
